(19) United States
(12) Patent Application Publication
(10) Pub. No.: US 2020/0005169 A1
(43) Pub. Date: Jan. 2, 2020

(54) SYSTEM FOR PREDICTING MOOD OF USER BY USING WEB CONTENT, AND METHOD THEREFOR

(71) Applicant: SANGMYUNG UNIVERSITY INDUSTRY-ACADEMY COOPERATION FOUNDATION, Seoul (KR)

(72) Inventors: Min Cheol WHANG, Goyang-si, Gyeonggi-do (KR); Young Ho JO, Namyangju-si, Gyeonggi-do (KR); Hea Jin KIM, Seoul (KR)

(73) Assignee: SANGMYUNG UNIVERSITY INDUSTRY-ACADEMY COOPERATION FOUNDATION, Seoul (KR)

(21) Appl. No.: 16/482,249

(22) PCT Filed: Feb. 1, 2017
(86) PCT No.: PCT/KR2017/001075

§ 371 Date: Jul. 30, 2019

(30) Foreign Application Priority Data
Feb. 1, 2017 (KR) 10-2017-0014357

(51) Int. Cl. G06N 5/04; G06F 16/951; G06F 16/906; G06F 16/901; G06Q 30/02; G06F 17/27

(52) U.S. Cl. CPC G06N 5/04; G06F 16/951; G06F 16/906; G06N 20/00; G06Q 30/0201; G06F 17/2755; G06F 17/2705; G06F 16/9024

(57) ABSTRACT

A system for predicting an emotion of a user by using a web content includes a URL collection unit for collecting a URL of a web page; a representative URL selection unit for selecting a category-specific representative URL, a basic emotion-specific representative URL, and a dimensional emotion-specific representative URL according to contents included in a plurality of collected URLs; a representative vocabulary set creation unit for creating vocabulary sets representing a category, a basic emotion, and a dimensional emotion, respectively, on the basis of the selected representative URLs; a vocabulary extraction unit for crawling a plurality of texts; and a selection unit for comparing document similarities between the plurality of extracted vocabularies and the vocabulary sets.

### TECHNICAL FIELD

The present invention relates to a system for predicting an emotion of a user by using a web content and a method therefor, more specifically, the system for predicting an emotion of a user by using the web content and the method therefor that determine a category and emotion information of a web page accessed by the user by building a database for classifying automatically categories and emotion information by using a text of web contents.

### BACKGROUND ART

With the development of smart devices including smartphones, the Internet usage base has expanded from PC to mobile. Accordingly, new contents which can be easily enjoyed by the mobile are increasing. Web content refers to all contents created, distributed and consumed on a web.

Such web content is consumed anytime, anywhere on various mobile devices. The development of SNS changes the distribution and consumption patterns of contents. In particular, news mainly uses SNS without using online sites or dedicated apps.

As types of the web content, there are video, music, cartoons, text, and the like. Among these, the topics that the text wants to convey determine the category of content and the nuances felt in the text determine the emotion.

Until now, research on the content consumed in daily life has been merely a statistical analysis of the devices, hours, and the like of the web content. However, by analyzing the content that individuals consume in their daily lives, it is possible to grasp a daily history of consumers' concerns and worries and the like.

In addition, there is an advantage that a result obtained by analyzing consumption data can be used for marketing a content recommendation service and the like according to a consumption behavior. However, in the related art, since data collection on content consumption behavior is mainly conducted only through surveys, there is a problem that accuracy is somewhat lowered, so there is a limit in using it for trend analysis or treating it as purified data.

A background technology of the present invention is disclosed in Republic of Korea Patent Publication No. 10-1465756 (Dec. 3, 2014).

### DISCLOSURE

### Technical Problem

The technical problem to be achieved by the present invention is to provide a system for predicting an emotion of a user by using a web content and a method therefor that determine a category and emotion information of a web page accessed by the user by building a database for classifying automatically the category and the emotion information by using a text of web contents.

### Technical Solution

A system for predicting an emotion of a user by using a web content according to an embodiment of the present invention for achieving the technical problem includes a URL (uniform resource locator) collection unit for collecting a URL of a web page including a predetermined number of or more texts among a plurality of web pages connected using a web browser previously installed in a user terminal; a representative URL selection unit for selecting a category-specific representative URL, a basic emotion-specific representative URL, and a dimensional emotion-specific representative URL according to contents included in a plurality of collected URLs; a representative vocabulary set creation unit for creating vocabulary sets representing a category, a basic emotion, and a dimensional emotion, respectively, on the basis of the selected representative URLs; a vocabulary extraction unit for crawling a plurality of texts included in a web page of a URL to be classified, and then extracting a plurality of vocabularies which are classified into morpheme units through natural language processing (NLP); and a selection unit for comparing document similarities between the plurality of extracted vocabularies and the vocabulary sets representing a category, a basic emotion, and a dimensional emotion, respectively, which are created by the representative vocabulary set creation unit, and then selecting a category, a basic emotion, and a dimensional emotion of the web page.

In addition, the system for predicting an emotion of a user further includes a category creation unit for arranging the vocabularies collected from a plurality of websites in a hierarchical structure, and for creating a plurality of categories by adding and deleting according to the frequency selected by the user; a basic emotion creation unit for creating a basic emotion table by using a plurality of sub keywords arranged on the basis of a plurality of emotions by a user; and a dimensional emotion creation unit for creating a dimensional emotion graph by using keywords arranged in a 2D graph on the basis of the plurality of emotions by the user.

In addition, the representative URL selection unit may select the category-specific representative URL according to a matched result obtained by matching contents included in the collected plurality of URLs with the created plurality of categories, respectively, select the basic emotion-specific representative URL according to a matched result obtained by matching contents included in the collected plurality of URLs with keywords of the created basic emotion table, respectively, and select the dimensional emotion-specific representative URL according to a matched result obtained by matching the contents included in the collected plurality of URLs with the keywords arranged in the created dimensional emotion graph, respectively. In addition, the representative vocabulary set creation unit may crawl the plurality of texts included in the URL, and then may create a vocabulary set representing a category by separating vocabulary into morpheme units and adding nouns of a morpheme form through natural language processing (NLP), and create a vocabulary set representing a basic emotion and a vocabulary set representing a dimensional emotion by adding a noun, a verb, and an adjective of the morpheme form.

In addition, the selection unit may select a category of the highest document similarity as a category of the URL accessed by the user by comparing document similarities between the extracted plurality of vocabularies and the vocabulary set representing the category, select a vocabulary of the basic emotion of the highest document similarity as the basic emotion of the URL accessed by the user by comparing the document similarities between the extracted plurality of vocabularies and the vocabulary set representing the basic emotion, and select a vocabulary of the dimensional emotion of the highest document similarity as the dimensional emotion of the URL accessed by the user by comparing the document similarities between the extracted plurality of vocabularies and the vocabulary set representing the dimensional emotion.

In addition, a method for predicting an emotion of a user performed by a system for predicting an emotion of a user by using a web content according to an embodiment of the present invention includes a step of collecting a URL (uniform resource locator) of a web page including a predetermined number of or more texts among a plurality of web pages connected by using a web browser previously installed in a user terminal; a step of selecting the category-specific representative URL, the basic emotion-specific representative URL, and the dimensional emotion-specific representative URL according to contents included in the collected plurality of URLs; a step of creating the vocabulary sets representing each of the category, the basic emotion, and the dimensional emotion from the selected representative URLs; a step of crawling a plurality of texts included in the web page of the URLs to be classified and then extracting separated plurality of vocabularies by separating vocabulary into morpheme units through the natural language processing (NLP); and a step of selecting the category, the basic emotion, and the dimensional emotion of the web page by comparing the document similarities between the extracted plurality of vocabularies and the representative vocabulary sets of the category, the basic emotion, and the dimensional emotion which are created.

### Advantageous Effects

According to the present invention, as described above, since a database for classifying automatically a category, a basic emotion, and a dimensional emotion by using a text of web contents is built, and a category and emotion information of a web page accessed by a user by using the database are determined, there are advantages that it is possible to collect individual web contents consumption behavior, it is possible to analyze trends, and it is possible to use for various fields and purposes such as polling on the basis of categorization.

In addition, according to the present invention, there is an advantage that it is possible to use the present invention in marketing, such as a content recommendation service according to the consumption behavior.

### DESCRIPTION OF THE DRAWINGS

FIG. 1 is a block diagram illustrating a system for predicting an emotion of a user by using a web content according to an embodiment of the present invention.

FIG. 2 is a flowchart illustrating an operation flow of a method for predicting an emotion of a user using web contents according to the embodiment of the present invention.

FIG. 3 is a graph illustrating frequency inflection point in the embodiment of the present invention.

FIG. 4 is a graph illustrating normal distribution of frequency in the embodiment of the present invention.

FIG. 5 is a graph illustrating a category selection area in the embodiment of the present invention.

FIG. 6 is an example of a basic emotion table created in the embodiment of the present invention.

FIG. 7 is an example of a dimensional emotion graph created in the embodiment of the present invention.

### BEST MODE FOR CARRYING OUT INVENTION

The present invention includes a URL collection unit for collecting a URL of a web page including a predetermined number or more of texts among a plurality of web pages connected using a web browser previously installed in a user terminal, a representative URL selection unit for selecting a category-specific representative URL, a basic emotion-specific representative URL, and a dimensional emotion-specific representative URL according to contents included in a plurality of collected URLs, a representative vocabulary set creation unit for creating vocabulary sets representing a category, a basic emotion, and a dimensional emotion, respectively, on the basis of the selected representative URLs, a vocabulary extraction unit for crawling a plurality of texts included in a web page of a URL to be classified, and then extracting a plurality of vocabularies which are classified into morpheme units through natural language processing (NLP), and a selection unit for comparing document similarities between the plurality of extracted vocabularies and the representative vocabulary sets of a category, a basic emotion, and a dimensional emotion, respectively, which are created by the representative vocabulary set creation unit, and then selecting a category, a basic emotion, and a dimensional emotion of the web page.

### DESCRIPTION OF EMBODIMENTS

Hereinafter, exemplary embodiments of the present invention will be described in detail with reference to the accompanying drawings. In this process, the thickness of the lines or the size of the components illustrated in the drawings may be exaggerated for clarity and convenience of description.

In addition, terms to be described below are terms defined in consideration of functions in the present invention, which may vary according to a user's or operators intention or custom. Therefore, the definitions of these terms should be made on the basis of the contents throughout the specification.

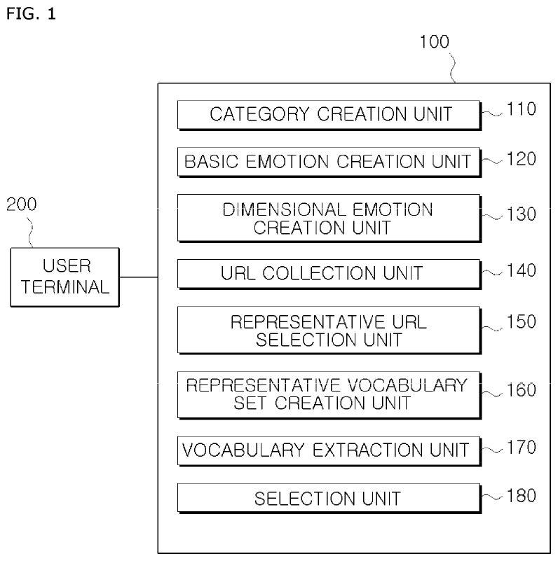

First, a system for predicting an emotion of a user by using a web content according to an embodiment of the present invention will be described by using FIG. 1.

FIG. 1 is a block diagram illustrating a system for predicting an emotion of a user by using a web content according to the embodiment of the present invention.

As described in FIG. 1, a user emotion prediction system 100 according to the embodiment of the present invention includes a category creation unit 110, a basic emotion creation unit 120, a dimensional emotion creation unit 130, a URL collection unit 140, a representative URL selection unit 150, a representative vocabulary set creation unit 160, a vocabulary extraction unit 170, and a selection unit 180.

First, the category creation unit 110 arranges the vocabularies collected from a plurality of websites in a hierarchical structure, and creates a plurality of categories by adding and deleting them according to frequency selected by a user.

The basic emotion creation unit 120 creates a basic emotion table by using a plurality of sub keywords arranged on the basis of a plurality of emotions by a user.

The dimensional emotion creation unit 130 creates a dimensional emotion graph by using keywords arranged in a 2D graph on the basis of the plurality of emotions by the user.

The URL collection unit 140 collects a URL (uniform resource locator) of a web page of a predetermined number of or more texts included in a web page among a plurality of web pages connected by using a web browser previously installed in a user terminal 200.

The representative URL selection unit 150 selects a category-specific representative URL, a basic emotion-specific representative URL, and a dimensional emotion-specific representative URL according to content included in the collected plurality of URLs collected by the URL collection unit 140.

At this time, the representative URL selection unit 150 selects the category-specific representative URL according to a matched result obtained by matching contents included in the plurality of URLs collected by the URL collection unit 140 with the created plurality of categories, respectively.

In addition, the representative URL selection unit 150 selects the basic emotion-specific representative URL according to a matched result obtained by matching the contents included in the plurality of URLs collected by the URL collection unit 140 with keywords of the created basic emotion table, respectively.

In addition, the representative URL selection unit 150 selects the dimensional emotion-specific representative URL according to a matched result obtained by matching the contents included in the plurality of URLs collected by the URL collection unit 140 with keywords arranged in the created dimensional emotion graph, respectively.

The representative vocabulary set creation unit 160 creates vocabulary sets representing each of a category, a basic emotion, and a dimensional emotion from the selected representative URLs.

Specifically, the representative vocabulary set creation unit 160 crawls a plurality of texts included in URL, and then creates a vocabulary set representing the category by separating vocabulary into morpheme units and adding nouns of the morpheme form through the natural language processing (NLP), and creates a vocabulary set representing the basic emotion and a vocabulary set representing a dimensional emotion by adding a noun, a verb, and an adjective of the morpheme form.

The vocabulary extraction unit 170 crawls the plurality of texts included in the web page of the URL to be classified, and then extracts a plurality of vocabularies separated by separating vocabulary into morpheme units through the natural language processing (NLP).

Finally, the selection unit 180 compares each of the document similarities between the plurality of vocabularies extracted from the vocabulary extraction unit 170 and the representative vocabulary sets of the category, the basic emotion, and the dimensional emotion created from the representative vocabulary set creation unit 160, and selects the category, the basic emotion, and the dimensional emotion of the web page of the URL to be classified.

Here, the document similarity is numerical representation of the degree of association between two documents. At this time, since the document is represented by a vector, the document similarity can be obtained by calculating the vector. As commonly used document similarity measurement methods, there are cosine coefficient, Jaccard coefficient, dice coefficient, Euclidean distance, and vector inner product. The embodiment of the present invention uses a cosine coefficient method, but it is not necessarily limited thereto.

Specifically, the selection unit 180 compares the document similarity between the plurality of vocabularies extracted from the vocabulary extraction unit 170 and the vocabulary set representing the category, and selects a category of the highest document similarity as a category of URL accessed by the user.

The selection unit 180 compares the document similarity between the plurality of vocabularies extracted from the vocabulary extraction unit 170 and the vocabulary set representing the basic emotion, and selects a vocabulary of the basic emotion of the highest document similarity as the basic emotion of the URL accessed by the user.

The selection unit 180 compares the document similarity between the plurality of vocabularies extracted from the vocabulary extraction unit 170 and the vocabulary set representing the dimensional emotion, and selects a vocabulary of dimensional emotion of the highest document similarity as a dimensional emotion of the URL accessed by the user.

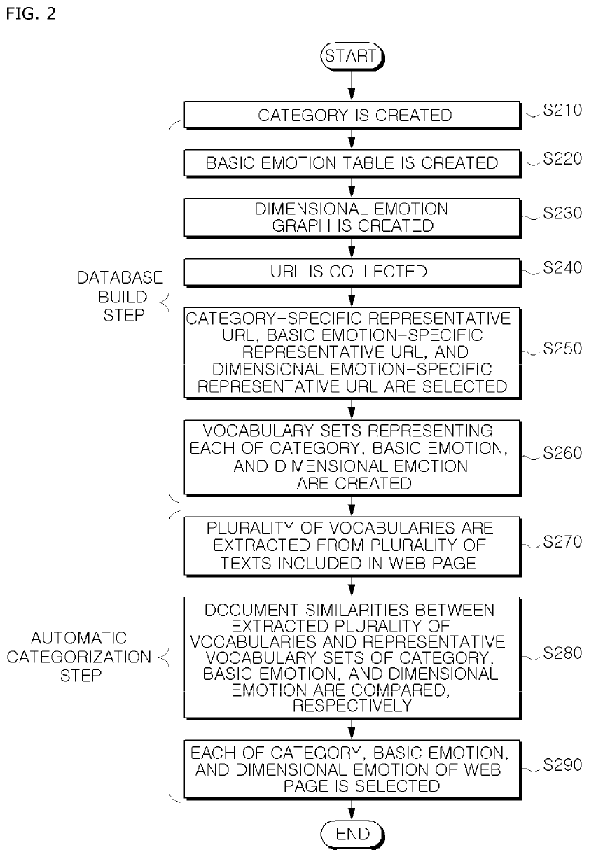

Hereinafter, a method for predicting an emotion of a user using web contents according to the embodiment of the present invention will be described by using FIG. 2.

FIG. 2 is a flowchart illustrating an operation flow of the method for predicting an emotion of a user using the web contents according to the embodiment of the present invention. Referring to this, a detailed operation of the present invention will be described.

The method for predicting an emotion of a user using the web contents according to the embodiment of the present invention includes a database build step of building a database as a whole, and an automatic categorization step of selecting the category, the basic emotion, and the dimensional emotion of the web page to be classified by using the built database. As illustrated in FIG. 2, the database build step includes steps of S210 to S260, and the automatic categorization step includes steps of S270 to S290.

To build the database, first, the category creation unit 110 of the user emotion prediction system 100 arranges vocabularies collected from a plurality of websites in a hierarchical structure, and creates the plurality of categories by adding and deleting them according to frequency selected by the user (S210).

That is, the category creation unit 110 first collects menu names used in portals, news, blogs, and the like to make categories consumed through the web. At this time, the first category is created by creating the hierarchical structure on the basis of the collected vocabularies. Then, the latest category is reflected in the first category, and the final category with adjusted number is created by adding and deleting categories.

The basic emotion creation unit 120 creates the basic emotion table by using a plurality of sub keywords arranged on the basis of the plurality of emotions by the user (S220).

The dimensional emotion creation unit 130 creates the dimensional emotion graph by using keywords arranged in a 2D graph on the basis of the plurality of emotions by the user (S230).

Specifically, the creation of the category, the basic emotion table, and the dimensional emotion graph in S210 to S230 may be created in the following manner through a survey. For example, for the survey, 40 subjects, in their 20s and 40s, are recruited and the subjects perform three tasks of category classification, basic emotion classification, and two-dimensional emotion classification. At this time, questionnaire for response may be made in an Excel format and the survey result may be received through e-mail.

First, groups are divided as ten groups of four people for classification, and the same URL is given for each group. That is, four subjects respond to one URL. Assuming that the last created category is 136, it is very difficult to select one of the 136 categories, so the main category is presented and the sub-category within the major category is selected. When it is determined that there is no corresponding category within the general category, the category to be added is listed. In this process, a category with a low selection rate may be deleted, and a category with many additions may be created as a new category.

The emotion felt in the contents of URL is classified to classify the basic emotion and the basic emotion felt in the contents of URL is selected to collect a representative vocabulary. At this time, the basic emotion uses Ekman's six basic emotions (happiness, surprise, anger, disgust, sadness, and fear).

Finally, for dimensional emotion classification, an emotion felt in the contents of URL is mapped with Russell's 28 two-dimensional emotions. At this time, the subject inputs an x coordinate and a y coordinate as numbers between—ten to ten, respectively.

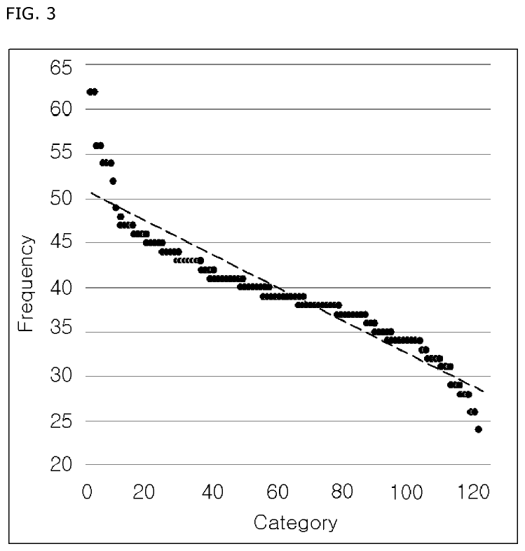

FIG. 3 is a graph illustrating frequency inflection point in the embodiment of the present invention.

Here, the frequency is the number of URLs on the basis of the category selected by the subjects. Since ten URLs are assigned per category and four people are assigned per URL, the default frequency per category is 40. To determine the criteria for deleting categories with low selectivity, the frequencies of 121 categories, excluding other categories, are analyzed. The mean of the frequencies is 39.57 and the standard deviation is 6.82.

As illustrated in FIG. 3, the rightmost inflection point of the three inflection points is the inflection point of the lower frequency. The frequency of this point is 30. Therefore, categories with a category selection frequency of 30 or less are a subject to be deleted.

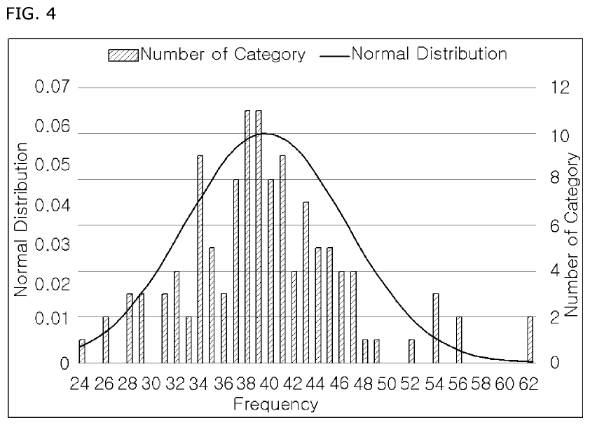

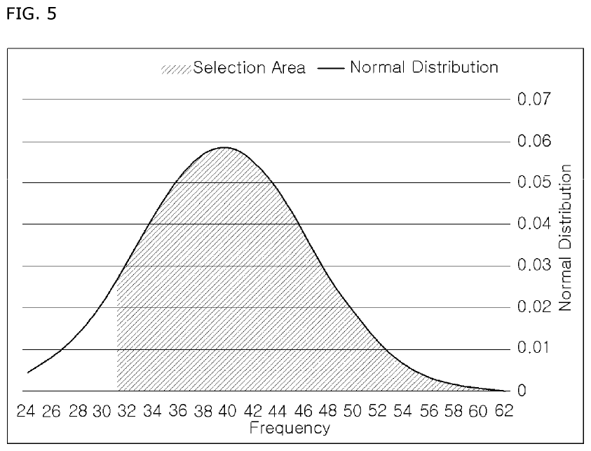

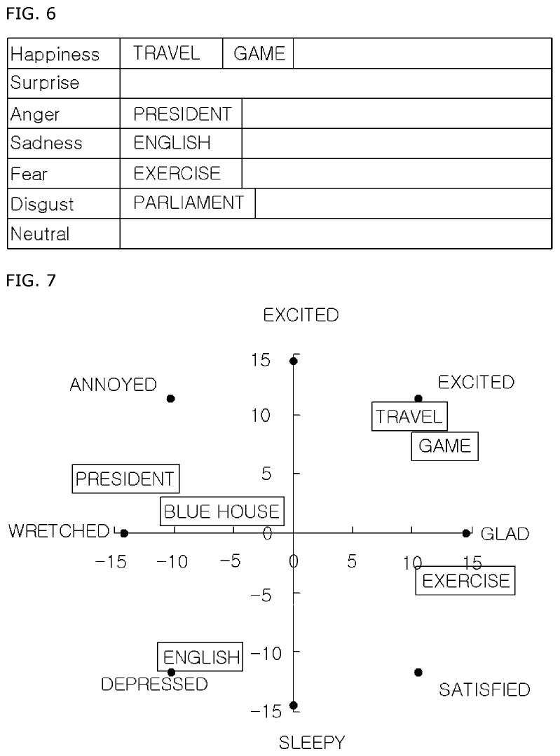

FIG. 4 is a graph illustrating the normal distribution of frequency in the embodiment of the present invention, and FIG. 5 is a graph illustrating a category selection area in the embodiment of the present invention.

For further confirmation, the normal distribution of frequencies is analyzed as illustrated in FIG. 4. When the cumulative 10% or less of the normal distribution is determined as the category deletion criterion, the frequency becomes 30 or less as illustrated in FIG. 5.

As illustrated in FIG. 3 to FIG. 5, it is defined that a threshold of the frequency is 30 on the basis of the inflection point of the frequency and normal distribution analysis. When there are lower than or equal to 30 categories to be selected, they become targets to be deleted. As a result, six categories are deleted, and Table 1 below represents categories deleted because the frequency is lower than or equal to 30.

TABLE 1

| Main category | Sub category | Frequency |
|---|---|---|
| Administration | Administration > Blue House | 26 |
| Society | Society > Overseas Koreans | 28 |
| Economy | Economy > Insurance | 28 |
| Culture | Culture > Broadcasting > Travel | 28 |
| | Abroad | |
| Life | Life > Cooking > Taste | 26 |
| | Expression/Taste Comparison | |
| Life | Life > Travel > Travel | 29 |
| | Abroad > Accommodation | |

In addition, the subjects create the categories that need to be added, with assuming that the number of categories created is 84, the average frequency of additional categories is 1.43, and the standard deviation is 1.15. In order to determine a target to be added among them, the following equation 1 is used to obtain category addition index (CAI).

$${CAI}_{n} = \frac{{CategoryFrequency}_{n}}{Max ( CategoryFrequency )} S {ParticipantCount}_{n} \qquad [ Equation 1 ]$$

That is, the category addition index (CAI) is calculated by normalizing by dividing the category frequency (Category Frequency) by the maximum value of the total category frequency and multiplying the Participant Count to which the category is added. When a subject adds the same category multiple times, a biased opinion may determine the additional category, which is multiplied by the number of subjects to prevent this. For example, in the “culture>reviews” category, six frequencies are generated, but all are selected by the same subject, so when one is selected as an additional category, one opinion is linked to the category addition. Therefore, to prevent this, the category addition index is obtained by multiplying the number of subjects. The category addition index thus calculated is finally selected as an additional category only when it is larger than the average of the frequency of each category.

The URL collection unit 140 collects a URL (uniform resource locator) of the web page of which the number of texts included in the web page is greater than or equal to a predetermined number among the plurality of web pages connected by using a web browser previously installed on the user terminal 200 (S240).

At this time, the collector 140 may collect the URL by using the web browser app for Android. That is, when the app is installed on the user terminal 200 and the web page is viewed through the web browser, a corresponding URL is stored. At this time, since many pages are redirected to another page, it is preferable to store only the URL staying for a set time (for example, 3 seconds).

In addition, the URL collection unit 140 classifies web page types and assigns them to appropriate categories according to contents. At this time, the web page type may be divided into main, search, content, and error.

Table 2 represents the number of collected web pages on the basis of types.

TABLE 2

| URL Type | Number | Rate | Remark |
|---|---|---|---|
| Total | 4488 | 100% | |
| Contents | 2669 | 59.5% | General Content |
| Search | 1471 | 32.8% | Search URL |
| Main | 177 | 3.9% | Main or List URL |
| Error | 81 | 1.8% | Error Generation |
| | | | URL |
| Redirect | 46 | 1.0% | URL Moved From |
| | | | Other Page |
| No Text | 36 | 0.8% | URL Without Text |
| Video | 6 | 0.1% | URL With Video |
| | | | Only |
| Comment | 2 | | Comment URL |

Here, since the survey needs to collect the vocabulary representing the categories, only the URL classified as Contents is used to use the web pages with much text.

The representative URL selection unit 150 selects the category-specific representative URL, the basic emotion-specific representative URL, and the dimensional emotion-specific representative URL according to the contents included in the plurality of URLs collected by the URL collection unit 140 (S250).

At this time, the representative URL selection unit 150 matches the contents included in the plurality of URLs collected by the URL collection unit 140 with the plurality of categories created by the category creation unit 110, respectively, and selects the category-specific representative URL according to the matched result.

In addition, the representative URL selection unit 150 matches the contents included in the plurality of URLs collected by the URL collection unit 140 with the keywords of the basic emotion table created by the basic emotion creation unit 120, respectively, and selects the basic emotion-specific representative URL according to the matched result.

Finally, the representative URL selection unit 150 matches the contents included in the plurality of URLs collected by the URL collection unit 140 with the keywords arranged in the dimensional emotion graph created by the dimensional emotion creation unit 130, respectively, and selects the dimensional emotion-specific representative URL according to the matched result.

Specifically, the representative URLs are selected to extract vocabularies representing 28 dimensional emotions. At this time, since dimensional emotion is input by x and y coordinates, an angle of each dimensional emotion is obtained. An angle of the dimensional emotion is obtained by using the method of Ross (1938) used by Russell. Since an emotion layout of the dimensions and a emotion layout of survey are different, an angle obtained from 90 degrees or 450 degrees is subtracted to match the sink. A range of angle is determined by the median of an angle of adjacent emotion.

Table 3 represents angles of the dimensional emotions and ranges of the angles.

TABLE 3

| dimensional emotion | angle | angle range |
|---|---|---|
| Aroused | 16.2 | 6.7~18.2 |
| Astonished | 20.2 | 18.2~30.8 |
| Excited | 41.4 | 30.8~53.2 |
| Delighted | 65.1 | 53.2~73.6 |
| Happy | 82.2 | 73.6~89.5 |
| Pleased | 96.8 | 89.5~98.5 |
| Glad | 100.2 | 98.5~110.8 |
| Serene | 121.4 | 110.8~123.7 |
| Content | 126.0 | 123.7~127.9 |
| Satisfied | 129.8 | 127.9~129.9 |
| At ease | 130.1 | 129.9~131.3 |
| Relaxed | 132.6 | 131.3~133.2 |
| Calm | 133.8 | 133.2~156 |
| Sleepy | 178.1 | 156~180.5 |
| Tired | 182.8 | 180.5~188.1 |
| Droopy | 193.4 | 188.1~201.4 |
| Bored | 209.5 | 201.4~224.9 |
| Depressed | 240.4 | 224.9~241 |
| Gloomy | 241.6 | 241~248.1 |
| Sad | 254.7. | 248.1~258 |
| Miserable | 261.3 | 258~284.4 |
| Frustrated | 307.6 | 284.4~308.8 |
| Distressed | 310.1 | 308.8~315.7 |
| Annoyed | 321.2 | 315.7~326.3 |
| Afraid | 331.4 | 326.3~341 |
| Angry | 350.6 | 341~352 |
| Alarmed | 353.5 | 352~355.4 |
| Tense | 357.2 | 355.4~360.7 |

With reference to Table 3, input coordinates are converted into angles and whether which dimension's emotion angles fall within the range is compared. As a method of converting the angle, Excel ATAN2 function is used. When three or more persons input coordinates with the same dimensional emotion for each URL, the representative URL of the emotion is selected. When the input coordinate is 0, 0, there is no angle, so it is defined as “neutral”.

The representative vocabulary set creation unit 160 creates the vocabulary sets representing each of the category, the basic emotion, and the dimensional emotion from the representative URLs selected in S250 (S260).

Specifically, the representative vocabulary set creation unit 160 crawls the plurality of texts included in URL, and then creates the vocabulary set representing the category by separating vocabulary into morpheme units and adding nouns of the morpheme form through natural language processing (NLP), and creates the vocabulary set representing the basic emotion and the vocabulary set representing the dimensional emotion by adding a noun, a verb, and an adjective of the morpheme form.

At this time, BeautifulSoup in the Python library may be used to crawl the plurality of texts. BeautifulSoup is a representative library for importing data from HTML and XML files. BeautifulSoup in the Python library may be used to crawl a large number of text. So, “Ixml” which is a HTML parser is used to get the HTML code. And, a CSS selector in the HTML source is used to get only parts with content. At this time, there are many ways to use CSS for web pages. It is necessary to specify the CSS selector with content for each web page.

However, since it is virtually impossible to specify selectors for many web pages, a CSS class that is commonly used to apply the selectors to all web pages, is applied. By using the selector, a tag of content part is obtained and a text is stored in it. By using a storage procedure of MySQL, the text is stored and collected for URL.

In order to refine the collected text, it is separated into morpheme units by using the natural language processing. At this time, the separation by the morpheme unit is to leave only Hangul domain.

Here, the text refinement is to create text so that the document similarity can be measured, and the natural language processing API uses KoNLPy, which is frequently used when performing Korean natural language processing in Python. KoNLPy includes five tag packages used when the morphemes are separated. Among these, Kkma class, which is slower but handles Hangul best, is used. When the morphemes are separated, only words corresponding to a noun, a verb, and an adjective remain. By using the natural language processing, vocabulary sets of a noun, a verb, and an adjective of the morpheme form are formed for each URL. The vocabulary sets are added on the basis of category and duplicate vocabularies are removed.

Thus, the final vocabulary set is the vocabulary representing each of category, basic emotion, and dimensional emotion.

As described in S210 to S260, when the database is build, the user emotion prediction system 100 performs the automatic categorization step of selecting each of the category, the basic emotion, and the dimensional emotion of the web page to be classified.

In the automatic categorization step, the vocabulary extraction unit 170 crawls the plurality of texts included in the web page of the URL to be classified, and then separates vocabulary into morpheme units through the natural language processing (NLP) and extracts the separated plurality of vocabularies (S270).

At this time, since methods of the crawling and the natural language processing are previously described, duplicate descriptions will be omitted.

Finally, the selection unit 180 compares the document similarities between the plurality of vocabularies extracted from the vocabulary extraction unit 170 and the representative vocabulary sets of the category, the basic emotion, and the dimensional emotion created from the representative vocabulary set creation unit 160, respectively (S280), and selects the category, the basic emotion, and the dimensional emotion of the web page of the URL to be classified (S290).

Specifically, the document similarity is calculated by comparing the vocabulary extracted from the URL to be inferred with the representative vocabulary. The category of similarity is selected as the category of the URL accessed by the user. The document similarity between the plurality of vocabularies extracted from the vocabulary extraction unit 170 and the vocabulary set representing the category, is calculated and the category of the highest document similarity is selected as the category of URL accessed by the user.

The document similarity between the plurality of vocabularies extracted from the vocabulary extraction unit 170 and the vocabulary set representing the basic emotion, is calculated. The vocabulary of the basic emotion with the highest document similarity is selected as the basic emotion of the URL accessed by the user.

The document similarity between the plurality of vocabularies extracted from the vocabulary extraction unit 170 and the vocabulary set representing the dimensional emotion, is calculated, and the vocabulary of the dimensional emotion with the highest document similarity is selected as the dimensional emotion of the URL accessed by the user.

That is, in the automatic categorization step, content of the URL to be classified is compared with the vocabulary sets representing each of the category, the basic emotion, the dimensional emotion, and the compared result is categorized.

In addition, Table 4 represents a category classification match rate classified by frequency. Here, the match means that the category determined by the survey result and the category classified by the user emotion prediction system 100 are the same.

TABLE 4

| Classification | Training Data | Test Data |
|---|---|---|
| Contents Category | 95.5% (796) | 34.4% (209) |
| Discrete Emotion | 69.3% (596) | 53.0% (149) |
| Dimensional Emotion | 96.9% (196) | 51.0% (49) |

Here, Training Data represents a classification for URLs used as a representative, Test Data represents a new measurement target, and the parenthesis represents the number of URLs used.

That is, the category classification is performed for 2,669 URLs classified as Contents. The classification for the URL used as a representative shows a 95.5% match rate as represented in Table 4. The classification for the remaining URLs has a 34.4% match rate. The basic emotion classification is also proceeded in the same way, the URL used as a representative shows a 69.3% match rate, and the remaining URL has a 53.0% match rate. In the dimensional emotion classification, the URL used as a representative shows a 96.9% match rate, and the remaining URLs shows a 51.0% match rate.

As described above, the system for predicting an emotion of a user by using a web content and the method thereof according to the embodiment of the present invention builds a database for classifying automatically the category, the basic emotion, and the dimensional emotion by using the text of the web contents, and determines the category and the emotion information of the web page accessed by the user by using this such that there are effects that it is possible to collect individual web contents consumption behavior, it is possible to analyze trends, and it is possible to use the method in various fields such as polling on the basis of categorization.

In addition, according to the embodiment of the present invention, there is an effect that it is possible to use the method in marketing, such as a content recommendation service according to the consumption behavior.

Although the present invention has been described with reference to the embodiments illustrated in the drawings, this is merely exemplary, and it will be understood by those skilled in the art that various modifications and equivalent other embodiments are possible. Therefore, the true technical protection scope of the present invention will be defined by the technical spirit of the following claims.

1. A system for predicting an emotion of a user by using a web content comprising:
a URL (uniform resource locator) collection unit for collecting a URL of a web page including a predetermined number of or more texts among a plurality of web pages connected using a web browser previously installed in a user terminal;
a representative URL selection unit for selecting a category-specific representative URL, a basic emotion-specific representative URL, and a dimensional emotion-specific representative URL according to contents included in a plurality of collected URLs;
a representative vocabulary set creation unit for creating vocabulary sets representing a category, a basic emotion, and a dimensional emotion, respectively, on the basis of the selected representative URLs;
a vocabulary extraction unit for crawling a plurality of texts included in a web page of a URL to be classified, and then extracting a plurality of vocabularies which are classified into morpheme units through natural language processing (NLP); and
a selection unit for comparing document similarities between the plurality of extracted vocabularies and the vocabulary sets representing a category, a basic emotion, and a dimensional emotion, respectively, which are created by the representative vocabulary set creation unit, and then selecting a category, a basic emotion, and a dimensional emotion of the web page.

2. The system for predicting an emotion of a user by using a web content of claim 1, further comprising:
a category creation unit for arranging the vocabularies collected from a plurality of websites in a hierarchical structure, and for creating a plurality of categories by adding and deleting according to frequency selected by the user;
a basic emotion creation unit for creating a basic emotion table by using a plurality of sub keywords arranged on the basis of a plurality of emotions by a user; and
a dimensional emotion creation unit for creating a dimensional emotion graph by using keywords arranged in a 2D graph on the basis of the plurality of emotions by the user.

3. The system for predicting an emotion of a user by using a web content of claim 2,
wherein the representative URL selection unit
selects the category-specific representative URL according to a matched result obtained by matching contents included in the collected plurality of URLs with the created plurality of categories, respectively,
selects the basic emotion-specific representative URL according to a matched result obtained by matching contents included in the collected plurality of URLs with keywords of the created basic emotion table, respectively, and
selects the dimensional emotion-specific representative URL according to a matched result obtained by matching the contents included in the collected plurality of URLs with the keywords arranged in the created dimensional emotion graph, respectively.

4. The system for predicting an emotion of a user by using a web content of claim 1,
wherein the representative vocabulary set creation unit
crawls the plurality of texts included in the URL, and then creates a vocabulary set representing a category by separating vocabulary into morpheme units and adding nouns of a morpheme form through natural language processing (NLP), and
creates a vocabulary set representing a basic emotion and a vocabulary set representing a dimensional emotion by adding a noun, a verb, and an adjective of the morpheme form.

5. The system for predicting an emotion of a user by using a web content of claim 4,
wherein the selection unit
selects a category of the highest document similarity as a category of the URL accessed by the user by comparing document similarities between the extracted plurality of vocabularies and a vocabulary set representing the category,
selects a vocabulary of a basic emotion of the highest document similarity as a basic emotion of the URL accessed by the user by comparing the document similarities between the extracted plurality of vocabularies and a vocabulary set representing the basic emotion, and
selects a vocabulary of a dimensional emotion of the highest document similarity as a dimensional emotion of the URL accessed by the user by comparing the document similarities between the extracted plurality of vocabularies and a vocabulary set representing the dimensional emotion.

6. A method for predicting an emotion of a user performed by a system for predicting an emotion of a user by using a web content, the method comprising:
a step of collecting a URL (uniform resource locator) of a web page including a predetermined number of or more texts among a plurality of web pages connected by using a web browser previously installed in a user terminal;
a step of selecting a category-specific representative URL, a basic emotion-specific representative URL, and a dimensional emotion-specific representative URL according to contents included in the collected plurality of URLs;
a step of creating vocabulary sets representing each of a category, a basic emotion, and a dimensional emotion from the selected representative URLs;
a step of crawling a plurality of texts included in the web page of the URLs to be classified and then extracting separated plurality of vocabularies by separating vocabulary into morpheme units through natural language processing (NLP); and
a step of selecting the category, the basic emotion, and the dimensional emotion of the web page by comparing the document similarities between the extracted plurality of vocabularies and the representative vocabulary sets of the category, the basic emotion, and the dimensional emotion which are created.

7. The method for predicting an emotion of a user of claim 6, further comprising:
a step of arranging vocabularies collected from a plurality of websites in a hierarchical structure, and creating a plurality of categories by adding and deleting according to frequency selected by the user;
a step of creating a basic emotion table by using a plurality of sub keywords arranged on the basis of a plurality of emotions by a user; and
a step of creating a dimensional emotion graph by using keywords arranged in a 2D graph on the basis of the plurality of emotions by the user.

8. The method for predicting an emotion of a user of claim 7,
wherein in the step of selecting the representative URL,
the category-specific representative URL is selected according to a matched result obtained by matching contents included in the collected plurality of URLs with the created plurality of categories, respectively,
the basic emotion-specific representative URL is selected according to a matched result obtained by matching contents included in the collected plurality of URLs with keywords of the created basic emotion table, respectively, and
the dimensional emotion-specific representative URL is selected according to a matched result obtained by matching the contents included in the collected plurality of URLs with the keywords arranged in the created dimensional emotion graph, respectively.

9. The method for predicting an emotion of a user of claim 6,
wherein in the step of creating the vocabulary set,
the plurality of texts included in the URL crawl, and then a vocabulary set representing a category is created by separating vocabulary into morpheme units and adding nouns of a morpheme form through natural language processing (NLP), and
a vocabulary set representing a basic emotion and a vocabulary set representing a dimensional emotion are created by adding a noun, a verb, and an adjective of the morpheme form.

10. The method for predicting an emotion of a user of claim 9,
wherein in the step of selecting,
a category of the highest document similarity as a category of the URL accessed by the user is selected by comparing document similarity between the extracted plurality of vocabularies and the vocabulary set representing the category,
a vocabulary of basic emotion of the highest document similarity as a basic emotion of the URL accessed by the user is selected by comparing the document similarities between the extracted plurality of vocabularies and the vocabulary set representing the basic emotion, and
a vocabulary of dimensional emotion of the highest document similarity as a dimensional emotion of the URL accessed by the user is selected by comparing the document similarities between the extracted plurality of vocabularies and a vocabulary set representing the dimensional emotion.
